(19) United States
(12) Patent Application Publication
(10) Pub. No.: US 2024/0419437 A1
(43) Pub. Date: Dec. 19, 2024

(54) MANAGEMENT OF BINARY SOFTWARE PATCHES

(71) Applicant: VMware LLC, Palo Alto, CA (US)

(72) Inventor: Sebastien Baudouin, Grenoble (FR)

(21) Appl. No.: 18/336,222

(22) Filed: Jun. 16, 2023

(51) Int. Cl. G06F 8/658; G06F 8/71

(52) U.S. Cl. CPC G06F 8/658; G06F 8/71

(57) ABSTRACT

Described herein are systems, methods, and software to manage code patches on a computer based on the deployment environment of the computer. In one implementation, a method includes, in response to a request to execute an application, identifying deployment environment information for the application on the computer. The method further includes determining one or more patches for the application based on the deployment environment information and applying the patches in the binary code for the application on the computer.

### BACKGROUND

In computers, software, including kernels and applications, can be deployed using images that comprise functions, variables, and other elements to implement the desired operation of the software. Typically, the images can include a single version of the code, which can require different images based on the deployment characteristics of the software. For example, a first image can be required for a first computer in a first deployment environment (e.g., processor configuration, optimization requirements, etc.), while a second image can be required for a second computer with a second deployment environment.

The different image requirements can cause inefficiencies in compiling the code for the software, as each image can require an individual compilation of the code. These inefficiencies are compounded as the quantity of images increase. Additionally, difficulties can arise in determining which of the images apply for a specific deployment environment, wherein an administrator or other mechanism will be responsible for selecting and deploying the required image.

### Overview

The technology described here manages binary software patches based on deployment environment information for the software. In one implementation, a method includes identifying a request to deploy software from an image and, in response to the request, identifying deployment environment information for the software. The method further includes determining one or more patches for the software based on the deployment environment information and applying the patches in binary code for the software.

In some implementations, the deployment environment information can comprise physical hardware information associated with a computer environment for the software or can comprise optimization information associated with optimizing the software for a use case in the computing environment.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a computer to deploy and patch code for software based on deployment information for the software according to an implementation.

FIG. 2 illustrates a method of operating a computer to manage patches for software based on deployment information for the software according to an implementation.

FIG. 3 illustrates a data structure to manage patches for software according to an implementation.

FIG. 4 illustrates an operational scenario of deploying a patch according to an implementation.

FIG. 5 illustrates an operational scenario of deploying a patch according to an implementation.

FIG. 6 illustrates an operational scenario of deploying a patch according to an implementation.

FIG. 7 illustrates a computing system to manage the application of patches to software according to an implementation.

### DETAILED DESCRIPTION

Computers use software to provide different operations on the computer. The software can include applications that can provide productivity, data processing operations, gaming, or some other application. Additionally, software can comprise operating systems and kernels that are used to provide a platform for other software applications, wherein the other software applications can include virtual machines, containers, and the like. When a request is generated to deploy software at a computer from an image, a patch manager, which can be included as part of the image, can identify deployment environment information to determine whether any patches included with the software should be implemented. The deployment environment information can include hardware information for the computer, optimization information, such as use case information for the software, or some other information. The hardware information can include processor type, memory size, memory type, or some other hardware information for the computer. The optimization information can include types of processes to be executed, energy requirements for the software, or some other information.

From the deployment environment information, the patch manager can select one or more patches to be applied to the software. In at least one example, when the software is provided as part of an image, the software can include a data structure, file, or other process that associates parameters from the deployment environment information (e.g., processor type) with information for applying one or more patches. The information can indicate the type of patch, addressing of code to be replaced, addressing or offsets associated with the new or patched code, no operation (NOP) to skip or move to the patched code, or some other information to apply each of the patches. The different types of patches can include a zone replacement type patches that replace portions or zones of the code with different code or add a new zone when the patch is applied, a function replacement type that replaces a first function with a second function, or a data patch type that can be used to replace a first variable value with a second variable value when the patch is applied. Although these are some examples of patches, other types of patches can be included based on the patches required for the software and different environment configurations.

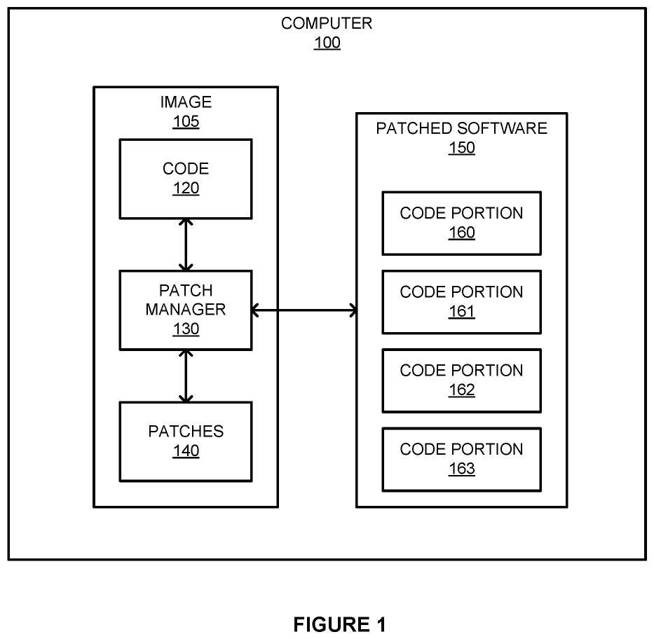

FIG. 1 illustrates a computer 100 to deploy and patch code for software based on deployment information for the software according to an implementation. Computer 100 can be an example of a host computer (host), desktop computer, laptop computer, or some other type of computer. Computer 100 includes image 105 that comprises code 120, patch manager 130, and patches 140 that are used to create patched software 150. Patched software 150 comprises code portions 160-163 that are representative of functions, variables, other elements to provide the desired operations of the functions.

In computer 100, a request is generated to deploy software associated with code 120, wherein code 120 can be included as part of an image 105 with patches 140. An image or application image includes code, libraries, and other required data to make the software execute on a computer, such as computer 100. Here, patches 140 are included with code 120 that can be used to modify or patch the code based on deployment environment information for computer 100. The deployment environment information can include hardware information associated with computer 100, including processor type information, memory size information, memory speed information, storage configuration information, or some other information. Deployment environment information can, in addition to or in place of the hardware information, include optimization information, including use case information for the deployment of the software, energy efficiency information associated with the deployment of the software, or some other information associated with the software. The deployment environment information can be provided by an administrator associated with computer 100, can be extracted via hardware reporting in the firmware of computer 100, or can be obtained in some other manner.

For example, when a request is generated to deploy the software associated with image 105 at computer 100, patch manager 130 may extract hardware information from the firmware associated with computer 100. From the hardware information, patch manager can select the relevant one or more patches from patches 140. As an example, for a processor type associated with computer 140, patch manager 130 can identify a set of patches from patches 140 to be implemented in patched software 150. The patches can be used to replace portions of the code, add new portions of the code, remove portions of the code, or provide some other patch operation in association with the code. In some examples, the patches can be used to replace zones of code (e.g., insert a no-op or NOP) to skip unwanted code portion and use a desired portion of code, the patches can be used to replace functions, or can be used to replace variable values with a patched variable value. When the image for the software is created, the unpatched code, the patched code, and the data structure or file that indicates the configuration information for implementing the patches is included as part of the image. Thus, when a patch is required, the file can be used to update the code of the application to implement the patch (e.g., replace a portion of code, remove code, add code, replace a variable, etc.).

In some implementations, image 105 can be representative of a package for a kernel of an operating system. The patches indicated in patches 140 can be used to update different elements of the kernel such as the kernel modules, the boot process for the kernel, the kernel modules, or some other software element associated with the kernel. Although a kernel image is one example of software, similar operations can be performed with respect to other types of software, such as productivity, data processing, or some other application.

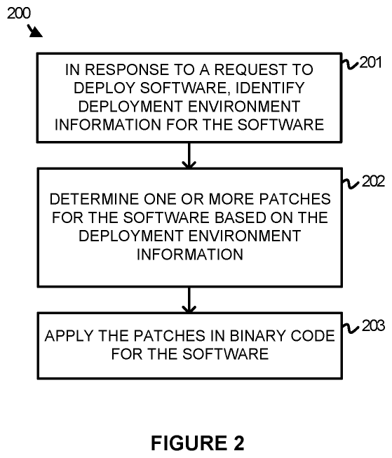

FIG. 2 illustrates a method 200 of operating a computer to manage patches for software based on deployment information for the software according to an implementation. The steps of method 200 are referenced parenthetically in the paragraphs that follow with reference to systems and elements of computer 100 from FIG. 1. In at least one example, method 200 can be implemented using patch manager 130 as part of image 105. Although demonstrated as operating from image 105, patch manager can be a separate process that identifies required patches and implements the patches as required.

Method 200 includes, in response to a request to deploy software from and image on a computer, identifying (201) deployment information for the software. The deployment information can comprise hardware information associated with the computer or can comprise optimization information associated with the type of deployment. The hardware information can comprise processor type information, memory size information, storage type information, storage size information, or some other hardware information associated with the computer. As an example, patch manager 130 can identify the processor type associated with computer 100, wherein the processor type can be defined at least in part using information provided by the firmware. In other examples, patch manager 130 can be provided information from an existing application, such as an operating system for the computer or an administrator of the computer. In addition to the hardware information, patch manager 130 can use optimization information associated with computer 100, wherein the optimization information can be used to manage functionality associated with the software. The optimization information can include use case information for the software at computer 100, energy efficiency requirements associated with computer 100, or some other optimization information. The optimization information can be defined by an administrator or can be gathered through other configuration parameters associated with other software (e.g., operating system).

Once the deployment environment information for the software is identified, method 200 further includes determining (202) one or more patches for the software based on the deployment environment information. In some implementations, the software can be provided with one or more data structures that maintain the various patches available for the software, wherein the patches can be provided as part of the image for the software. In at least one example, a data structure (or file) can associate a parameter from the deployment environment information with one or more patches associated with the parameter. For example, the deployment environment information can indicate a processor type associated with computer 100. From the processor type, patch manager 130 can search one or more data structures to identify patches that correspond to the processor type. Similar operations can be performed for other parameters from the deployment environment information, including combinations of parameters from the deployment environment information.

After the one or more patches are identified for the software, the method further provides applying (203) the one or more patches in binary code for the software on computer 100. The patches can comprise a zone patch type, a function patch type, data patch type. A zone patch type permits a first portion of code to be executed when the patch is not implemented and uses a second portion of code in place of the first portion of code when the patch is implemented. In some examples, a no-op or NOP can be implemented when the patch is required to skip or pass over the first portion of code and use the second portion of code. A function patch type is used to replace a first function with a second function when the patch is enabled. A NOP instruction can be used to skip the first function and apply the second function in some examples. A data patch type is used to modify an initial variable value in binary at application time. Thus, rather than using an original value from the unpatched software, a new value can be implemented at deployment time for the binary of the application. Although these are some examples of patch types, other types of patches can be used in some examples.

In some implementations, when the software is compiled, at least one data structure or file is created that can indicate the potential patches to the software. Each of the patches can identify the type of patch, the address of the patch in the software, the size of the patch, variable values if required, and a patch group to which the patch belongs. A patch group can correspond to one or more parameters identified as part of the deployment environment information. For example, a set of patches can be associated with a first group that is triggered based on a particular processor type being used on computer 100. Patch manager 130 will identify only the patches in patch groups triggered by the deployment environment information to be implemented in the binary patched software 150. Once identified, the patches associated with the group can be applied based on the information in the at least one data structure (e.g., location, offset, etc.) associated with each of the patches.

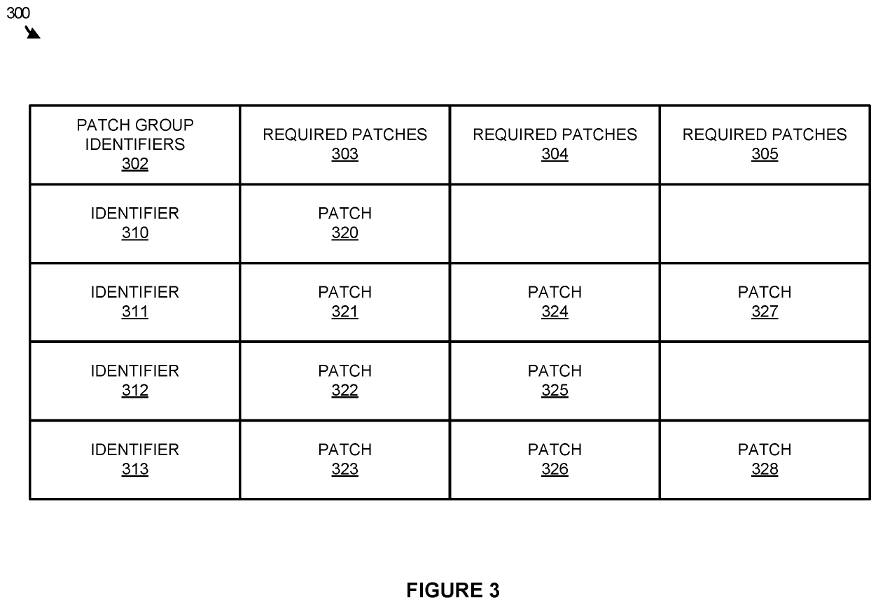

FIG. 3 illustrates a data structure 300 to manage patches for software according to an implementation. Data structure 300 includes columns for patch group identifiers 302 and required patches 303-305. Required patches 303-305 include patches 320-328, wherein the patches can correspond to different patch types, such as a zone patch type, a function patch type, data patch type.

When software is compiled to be provided to one or more computers as an image, patches can also be created that are defined in a file or data structure, such as data structure 300. These patches are used to modify the code of the software to reflect the deployment environment of the computer executing the software. As an example, binary code associated with a kernel can be patched based on the processor type that is executing the kernel. The patches can be used to optimize the hardware of the computer, overcome hardware deficiencies of the computer, or provide some other functionality in association with the computer.

Here, the file that is included with the software represents information as data structure 300, wherein different identifiers 310-313 correspond to different patches 320-328. In at least one implementation, the identifiers each correspond to one or more parameters identified as part of the deployment environment information. When a request is issued to deploy the software at a computer, a service executing on the computer can identify deployment environment information associated with the computer. From the deployment environment information, patch group identifiers can be determined that correspond to the computer. For example, the deployment environment information can indicate that patches associated with identifiers 310 and 312 are required for a computer. Accordingly, patches 320, 322, and 325 will be applied to the code to generate the patched software for a computer. However, one or more different patches can be applied at other computers based on the deployment environment information associated with the computers.

Each patch that is available in data structure 300 can include information about how and where the patch should be applied in the code for the software. The information for each of the patches can indicate the type of patch, the address associated the code for the patch (e.g., address of function or zone to be replaced with the patch, the address of the variable, etc.), address of the replacement code, the size of the patch, NOP definitions for triggering the patched code in place of the non-patched code, or some other information to implement the corresponding patch in the binary code for the software. As an example, a patch that replaces a first function with a second function can indicate an address of the first function, an address of the second function to implement the desired patch, a NOP location to skip the first function for the second function, or some other information to implement the desired function. Advantageously, a software image can include the required data for the unpatched software, and patches associated with different hardware configurations and/or optimization requirements.

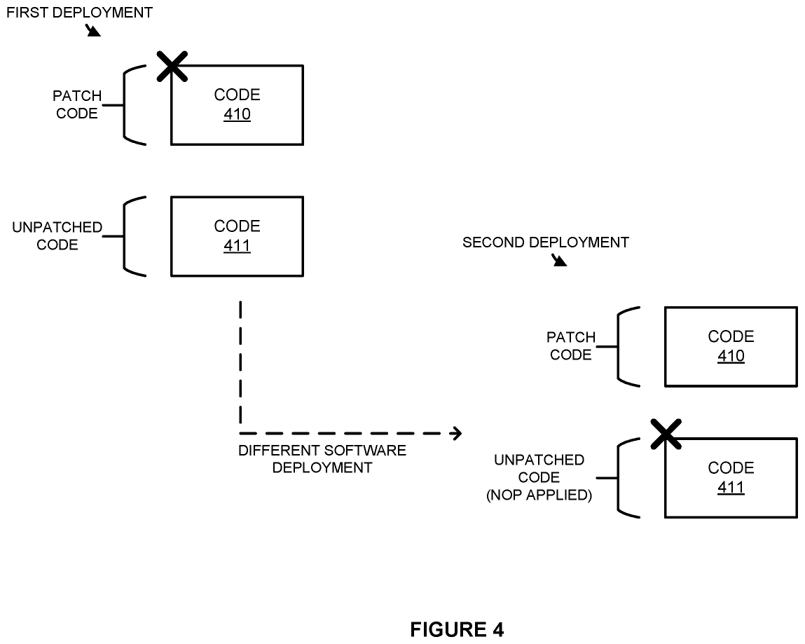

FIG. 4 illustrates an operational scenario of deploying a patch according to an implementation. Operational scenario 400 includes code 410-411 that are each representative of different zones within software. Code 410 is representative of the code that is used when a patch is applied whereas code 411 is representative of unpatched code for the software.

Referring to the first deployment of the software that corresponds to code 410-411, a patch manager can identify deployment environment information for the first deployment, wherein the deployment environment information can include hardware information for the computer associated with the first deployment or optimization information for the software at the first deployment. Based on the deployment environment information, the patch manager determines for the first deployment that unpatched code 411 should be implemented. For example, code 411 can correspond to code that is used in association with a first processor type. When the first processor type is identified as part of the deployment environment information, no patch will be identified for the software. Accordingly, code 411 will be used as part of the first deployment.

Turning to the second deployment of the software, which occurs on a different computer environment from the first deployment, the patch manager determines that the deployment environment information for the second environment qualifies for patched code 410. The patch manager can be included as part of the image associated with the software, can be a separate process deployed alongside the software, or can be some other process capable of identifying deployment environment information and selecting relevant patches for the software based on the information. Returning to the previous example regarding processor type, if the processor type indicates that patched code 410 should be implemented, the patch manager can implement NOPs within the code to prevent the execution of code 411, while permitting the execution of code 410. In some implementations, one or more groups of patches can be identified within a data structure or file based on the deployment environment information. Each of the one or more groups can be selected based on one or more parameters identified as part of the deployment environment information (e.g., processor type, memory size, optimization use case for the software, etc.). Once groups of patches are identified, the patches can be applied in the code for the computer. Here, applying the patch can include applying NOP operations, identifying offsets, or providing some other application to the software to provide the required patch to the software.

Although demonstrated in the example of FIG. 4 as a first zone being replaced by a second zone of code, similar operations can be performed by a patch manager to add or remove zones of code. For example, software can include a base configuration or unpatched version that does not require a zone of code. However, based on the deployment information for a computer environment, the patch manager can identify a patch to implement additional code (e.g., functions, variables, etc.). The patch can then be employed using NOPs identified in the patch information with the image, offsets indicated in the image, or some other operation.

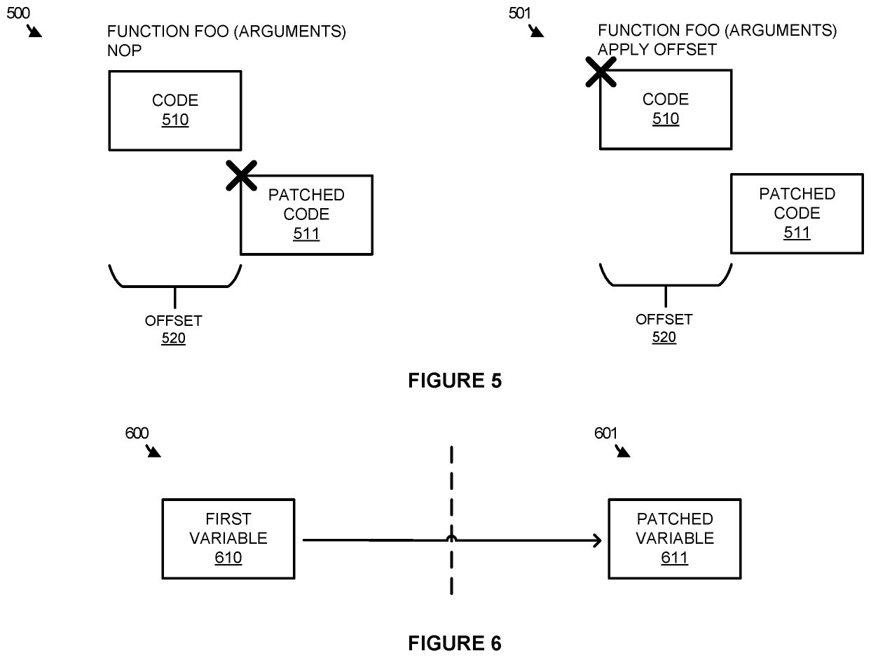

FIG. 5 illustrates an operational scenario of deploying a patch according to an implementation. The operational scenario includes non-patched deployment 500 and patched deployment 501. Deployments 500-501 each include code 510 and patched code 511 that are representative of the code for a function that can be deployed using a first function when an application is not patched and as a second function when the application is patched.

In non-patched deployment 500, code 510-511 is provided as part of an image to a computer, wherein a patch manager can identify deployment environment information for the application. The patch manager can be included as part of the image with the software in some examples. From the deployment environment information, the patch manager can determine that function FOO should be implemented without the patch thus permitting code 510 to be executed for the application. For example, the hardware configuration for the deployment environment may not trigger any patches in the software. Accordingly, the non-patched code 510 can be executed for the application.

Turning to patched deployment 501, patched deployment 501 is representative of a second computing environment or computer that requires patched code 511. When a request is generated to deploy the software at the second computer, the patch manager can identify deployment environment information and select at least the patch associated with patched code 511 based on the deployment environment information. In at least one example, the patch for patched code 511 can be represented as part of a group of one or more patches that are triggered based on parameters in the deployment environment information. For example, when a processor type for a computer is identified as a first type, then the patch associated with patched code 511 can be identified. The patch can identify the address associated with the patch, the offset 520 associated with the patch, the type of patch, or some other information associated with the patch. From the patch information, changes can be made in the code to provide the desired patch. Here, instead of executing the code 510, the offset instead directs function FOO to be provided using patched code 511.

FIG. 6 illustrates an operational scenario of deploying a patch according to an implementation. The operational scenario of FIG. 6 is representative of a replacement variable patch, wherein an unpatched first variable 610 is used in a non-patched condition 600 and patched variable 611 is used in a patched condition 601.

As described herein, when an image for software is requested to be deployed at a computing system, a patch manager can determine whether one or more patches are required for a computer based on deployment environment information. The information can include hardware information associated with the computer, optimization information associated with the use case of the software on the computer or some other information. The information can be obtained via firmware or other hardware reporting mechanisms, can be provided at least partially by a user of the computer, or can be provided in some other manner. Once the deployment environment information is identified, the patch manager can identify one or more patches to be applied to the code. In non-patched condition 600, first variable 610 is used, wherein the variable can comprise a global variable for the application in some examples. In contrast, in patched condition 601, first variable 610 is replaced with patched variable 611.

In some examples, at least one data structure or file can be included as part of a software image to provide configuration information for each of the patches, wherein the configuration information permits the application of a particular patch. Here, using the example of a patched variable, the configuration information for the patch can indicate the patch type, the group identifier for the patch (i.e., associates the patch with a group of one or more patches to be implemented based on parameters identified with the deployment environment information), or some other information. When a patch is triggered, the configuration information for the patch is applied, wherein the configuration information is used to replace the unpatched variable with the patched variable. The patching can include inserting pointers or other information to replace the required value.

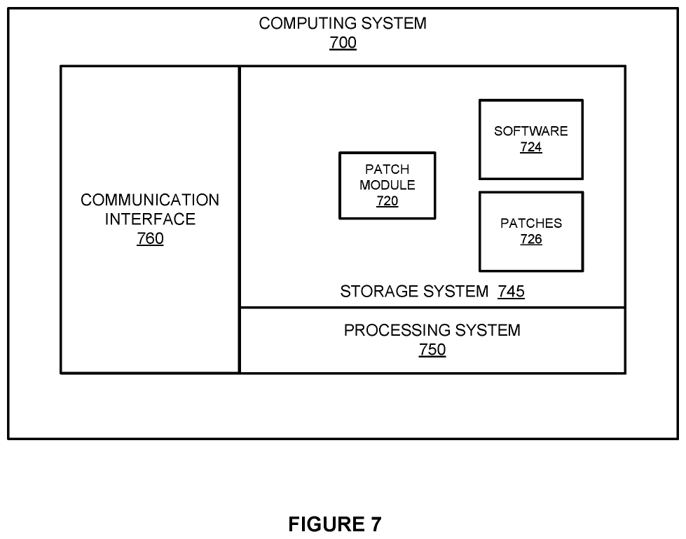

FIG. 7 illustrates a computing system 700 to manage the application of patches to software according to an implementation. Computing system 700 is representative of any computing system or systems with which the various operational architectures, processes, scenarios, and sequences disclosed herein for a computer can be implemented. Computing system 700 is an example of computer 100 of FIG. 1, although other examples may exist. Computing system 700 includes storage system 745, processing system 750, and communication interface 760. Processing system 750 is operatively linked to communication interface 760 and storage system 745. Communication interface 760 may be communicatively linked to storage system 745 in some implementations. Computing system 700 may further include other components such as a battery and enclosure that are not shown for clarity.

Communication interface 760 comprises components that communicate over communication links, such as network cards, ports, radio frequency (RF), processing circuitry and software, or some other communication devices. Communication interface 760 may be configured to communicate over metallic, wireless, or optical links. Communication interface 760 may be configured to use Time Division Multiplex (TDM), Internet Protocol (IP), Ethernet, optical networking, wireless protocols, communication signaling, or some other communication format—including combinations thereof. Communication interface 760 may be configured to communicate with other computing systems, such as desktop computers, servers, or some other computing system. In some examples, communication interface 760 can communicate with a server that distributes software 724, patches 726, and/or patch module 720, wherein software 724, patches 726, and/or patch module 720 can be provided as an image in some examples.

Processing system 750 comprises microprocessor (at least one processor) and other circuitry that retrieves and executes operating software from storage system 745. Storage system 745 may include volatile and nonvolatile, removable, and non-removable media implemented in any method or technology for storage of information, such as computer readable instructions, data structures, program modules, or other data. Storage system 745 may be implemented as a single storage device but may also be implemented across multiple storage devices or sub-systems. Storage system 745 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no case is the storage media a propagated signal.

Processing system 750 is typically mounted on a circuit board that may also hold the storage system. The operating software of storage system 745 comprises computer programs, firmware, or some other form of machine-readable program instructions. The operating software of storage system 745 comprises patch module 720 (example of patch manager 130 from FIG. 1), software 724, and patches 726. The operating software on storage system 745 may further include an operating system, utilities, drivers, network interfaces, applications, or some other type of software. When read and executed by processing system 750 the operating software on storage system 745 directs computing system 700 to operate as a computer described herein in FIGS. 1-6.

In at least one implementation, patch module 720 directs processing system 750 to identify a request to deploy software at computing system 700. The request can be automated or triggered from another process on computing system 700, can be triggered via a request of a user of computing system 700, or can be triggered in some other manner. As an example, software 724 can represent a kernel for an operating system to be deployed on computing system 700 and a user can generate a request to deploy or execute the software on the computing system.

In response to the request, patch module 720 directs processing system 750 to identify deployment environment information associated with computing system 700. The deployment environment information can comprise hardware information associated with computing system 700 or can identify optimization information associated with software 724 when deployed on computing system 700. First, if the deployment environment information comprises hardware information, patch module 720 can direct processing system 750 to identify processor type information, memory configuration information, or some other information associated with computing system 700. The information can be derived via firmware or other hardware reporting information, can be reported via other software on computing system 700, or can be determined via some other mechanism. Second, if the deployment environment information comprises optimization information associated with computing system 700, patch module 720 can direct processing system 750 to identify deployment specific optimizations associated with software 724, including use case information for the deployment of the software, energy efficiency information associated with the deployment of the software, or some other information associated with the software. The optimization information for software 724 can be determined based on other applications on computing system 700, based on configuration information provided by a user of computing system 700, or from some other source.

After identifying the deployment environment information, patch module 720 directs processing system 750 to determine one or more patches for software 724 based on the deployment information. In at least one implementation, when software is provided to computing system 700 as an image, the image includes patches 726 that comprises one or more files or data structures that indicate the different possible patches that can be employed in association with software 724. Each patch in patches 726 can be associated with a group identifier, wherein the group identifier can correspond to one or more patches. When a parameter is identified in association with the deployment environment information, a group identifier is identified that corresponds to the parameter. For example, when a first processor type is identified for computing system 700, patch module 720 can identify the group of one or more patches that correspond to an identifier for the first processor. Similar operations can be performed for any additional parameters identified in association with the deployment environment information. As an example, patches 726 can include patch identifiers that each correspond to one or more different patches in software 724. From the deployment environment information, patch module 720 directs processing system 750 to identify a subset of qualifying patches for computing system 700. Once the one or more patches are identified for software 724, patch module 720 directs processing system 750 to apply the one or more patches from patches 726 in software 724. The patches can comprise a zone patch type, a function patch type, data patch type, or some other patch type.

In some implementations, patches 726 can be included as part of one or more files or data structures that indicate various information associated with each of the patches. The information can indicate the group associated with the patch, the patch type, the address of the patch in software 724, information to implement NOPs within software to stop the execution of a function or zone in place of another function or zone, or some other information. When a group identifier is identified for the computing system, the information for each patch is identified and implemented in the code to provide the correct deployment of the software at the computing system. For example, a patch can be identified that is used as a zone patch type that replaces a first zone of code in the software with a second zone of code (i.e., portion). When the patch is identified, patch module 720 can identify the relevant portions of the code to be avoided using NOP operations, and instead direct the code to the second zone of code. In another example, rather than replacing a zone of code, the patch can be used to add or remove a particular zone of code within the software. Accordingly, without the patch the software can include a first portion of code, however, when the patch is triggered, patch module 720 can remove or bypass the code using a NOP to block the execution of the code.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method comprising:
in response to a request to deploy software from an image on a computer, identifying deployment environment information for the software;
determining one or more patches for the software based on the deployment environment information; and
applying the one or more patches in binary code for the software on the computer.

2. The method of claim 1, wherein the deployment environment information comprises hardware information associated with the computer.

3. The method of claim 2, wherein the hardware information comprises at least processor type and/or memory configuration information for the computer.

4. The method of claim 1, wherein the deployment environment information comprises optimization information.

5. The method of claim 1, wherein a patch of the one or more patches comprises a zone patch type, a function patch type, or a data patch type.

6. The method of claim 1 further comprising:
in response to a second request to deploy the software from the image on a second computer, identifying second deployment environment information for the software;
determining one or more second patches for the software based on the second deployment environment information; and
applying the one or more second patches in binary code for the software on the second computer.

7. The method of claim 1, wherein determining one or more patches for the software based on the deployment environment information comprises:
identifying a processor type associated with the computer;
selecting at least one patch that corresponds to the processor type from a database of potential patches.

8. The method of claim 1, wherein the software comprises a kernel for the computer.

9. A computing apparatus comprising:
a storage system;
a processing system operatively coupled to the storage system; and
program instructions on the storage system that, when executed by the processing system, direct the computing apparatus to:
in response to a request to deploy software from an image on a computer, identify deployment environment information for the software;
determine one or more patches for the software based on the deployment environment information; and
apply the one or more patches in binary code for the software on the computer.

10. The computing apparatus of claim 9, wherein the deployment environment information comprises hardware information associated with the computer.

11. The computing apparatus of claim 10, wherein the hardware information comprises at least processor type and/or memory configuration information for the computer.

12. The computing apparatus of claim 9, wherein the deployment environment comprises optimization information, and wherein the optimization information comprises at least use case information associated with the software on the computer.

13. The computing apparatus of claim 9, wherein a patch of the one or more patches comprises a zone patch type, a function patch type, or a data patch type.

14. The computing apparatus of claim 9, wherein the program instructions further direct the computing apparatus to:
in response to a second request to deploy the software from the image on a second computer, identify second deployment environment information for the software;
determine one or more second patches for the software based on the second deployment environment information; and
apply the one or more second patches in binary code for the software on the second computer.

15. The computing apparatus of claim 9, wherein determining one or more patches for the software based on the deployment environment information comprises:
identifying a processor type associated with the computer;
selecting at least one patch that corresponds to the processor type from a database of potential patches.

16. The computing apparatus of claim 9, wherein the software comprises a kernel for the computer.

17. An apparatus comprising:
one or more non-transitory computer readable storage media;
program instructions stored on the one or more non-transitory computer readable storage media that, when executed by a processing system, direct the processing system to:
in response to a request to deploy software from an image on a computer, identify deployment environment information for the software;
determine one or more patches for the software based on the deployment environment information; and
apply the one or more patches in binary code for the software on the computer.

18. The apparatus of claim 17, wherein the deployment environment information comprises hardware information associated with the computer or optimization information associated with a use case for the software on the computer.

19. The apparatus of claim 17, wherein the hardware information comprises at least processor type and/or memory configuration information for the computer.

20. The apparatus of claim 17, wherein determining one or more patches for the software based on the deployment environment information comprises:
identifying a processor type associated with the computer;
selecting at least one patch that corresponds to the processor type from a database of potential patches.
